(19) United States
(12) Patent Application Publication
(10) Pub. No.: US 2019/0325810 A1
(43) Pub. Date: Oct. 24, 2019

(54) DRIVING CIRCUIT AND OPERATING METHOD THEREOF

(71) Applicant: Raydium Semiconductor Corporation, Hsinchu (TW)

(72) Inventors: TZONG-YAU KU, Hsinchu City (TW); JUN-REN SHIH, Hsinchu City (TW)

(21) Appl. No.: 16/296,511

(22) Filed: Mar. 8, 2019

(30) Foreign Application Priority Data
Apr. 19, 2018 (TW) 107113385

(51) Int. Cl. G09G 3/20; G06F 3/041

(52) U.S. Cl. CPC G09G 3/2092; G06F 3/0416; G09G 2320/02; G09G 2310/0291; G06F 3/0412

(57) ABSTRACT

The present invention provides a driving circuit, applied to an In-cell touch display panel. The In-cell touch display panel has a touch period and a data driving period. The touch period occurs between the data driving period corresponding to a first data line and another data driving period corresponding to a second data line. A common voltage (VCOM) voltage of the In-cell touch display panel has a first level and a second level. The driving circuit includes a determining module and a compensating module. The determining module determines whether a difference between the first level and the second level is larger than a preset value. The compensating module is coupled to the determining module. When the determining result is that the difference between the first level and the second level is larger than the preset value, the compensating module compensates the common voltage in the touch period, so that the first level and the second level are substantially equal.

### RELATED APPLICATIONS

This application claims priority to Taiwan Application Serial Number 107113385, filed Apr. 19, 2018, which is herein incorporated by reference.

### BACKGROUND

### Technical Field

The present invention relates to a driving circuit and an operating method therefor, and specifically, particular to a driving circuit for an touch display panel and an operating method therefor.

### Related Art

A driving IC of a common liquid crystal display (LCD) panel continuously writes images into the panel. All conditions such as a gate pulse, a source line voltage, and a VCOM voltage are consecutive.

However, if a touch IC is integrated into the driving IC of the display panel, because the panel needs to insert time for touch sensing, a different image write state is caused, and stripes occurs. Further, as shown in FIG. 1, a period is inserted between a data driving period (TD) corresponding to a first data line DL1 and a data driving period corresponding to a second data line DL2 for touch sensing, which is so called a touch period (TT). After a pulse of the first data line DL1 ends, a period of time is inserted for touch sensing, and then the second data line DL2 consequently provides a pulse. In this case, a voltage of the panel, for example, a common voltage VCOM, has relatively much recovery time.

Therefore, when a signal on the first data line DL1 is off and when a signal on the second data line DL2 is off, VCOM voltages are obviously different from each other. Consequently, a voltage difference is caused. As shown in the figure, a voltage VTD of the data driving period TD is obviously different from a voltage VTT of the touch period TT. Consequently, inconsecutive images are caused, and a line or a stripe occurs.

### SUMMARY

In view of this, an embodiment of the present invention is to provide a driving circuit that can eliminate lines or stripes of a display image. The driving circuit is applied to an In-cell touch display panel, where the touch display panel is operated in a touch mode in a touch period and is operated in a data driving mode in a data driving period, the touch period occurs between the data driving period corresponding to a first data line and another data driving period corresponding to a second data line, a common voltage of the touch display panel has a first level when the data driving period corresponding to the first data line ends, and the common voltage has a second level when the another data driving period corresponding to the second data line starts. The driving circuit includes a determining module and a compensating module. The determining module is configured to determine whether a difference between the first level and the second level is greater than a preset value. The compensating module is coupled to the determining module. Under a condition that a determining result of the determining module is that the difference between the first level and the second level is greater than the preset value, the compensating module compensates the common voltage in the touch period, so that the first level and the second level are substantially equal.

Another embodiment of the present invention is to provide an operating method for a driving circuit that can eliminate lines or stripes of a display image. The operating method is applied to an In-cell touch display panel, where the touch display panel is operated in a touch mode in a touch period and is operated in a data driving mode in a data driving period, the touch period occurs between the data driving period corresponding to a first data line and another data driving period corresponding to a second data line, a common voltage of the touch display panel has a first level when the data driving period corresponding to the first data line ends, the common voltage has a second level when the another data driving period corresponding to the second data line starts, and the driving circuit includes a determining module and a compensating module; and including the following steps: (S1) the determining module determines whether a difference between the first level and the second level is greater than a preset value; and (S2) under a condition that a determining result of the determining module is that the difference between the first level and the second level is greater than the preset value, the compensating module compensates the common voltage in the touch period, so that the first level and the second level are substantially equal.

Compared with the prior art, the driving circuit and the operating method therefor of one embodiment of the present invention eliminate lines or stripes of a display image through compensating the common voltage.

### BRIEF DESCRIPTION OF THE DRAWINGS

FIG. 1 is a waveform diagram of a conventional touch display panel;

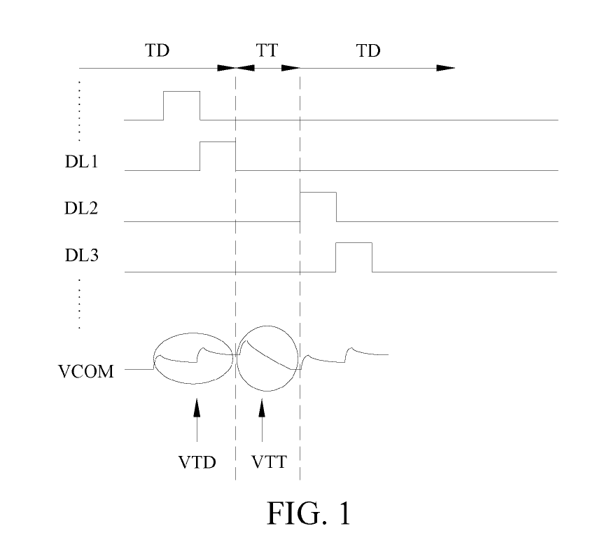

FIG. 2A and FIG. 2B are schematic diagrams of an embodiment of a driving circuit according to one embodiment the present invention;

FIG. 3A and FIG. 3B are schematic diagrams of another embodiment of a driving circuit according to one embodiment the present invention; and

FIG. 4 is a flowchart of an embodiment of an operating method for a display panel according to one embodiment the present invention.

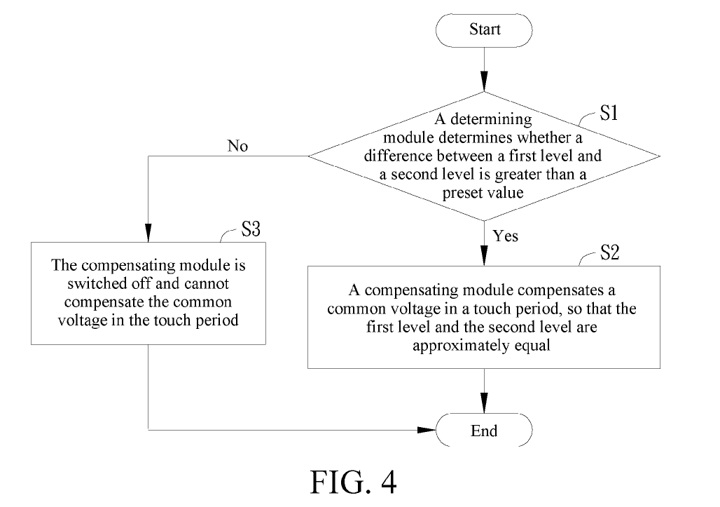

### DETAILED DESCRIPTION

The following describes a plurality of implementations of the present invention with reference to the accompanying drawings and words. For clarity, practical details will be described in the following descriptions. However, it should be understood that the practical details are not intended to limit the present invention. In addition, to simplify the figures, some conventional structures and elements are schematically drawn in a simple manner in the figures.

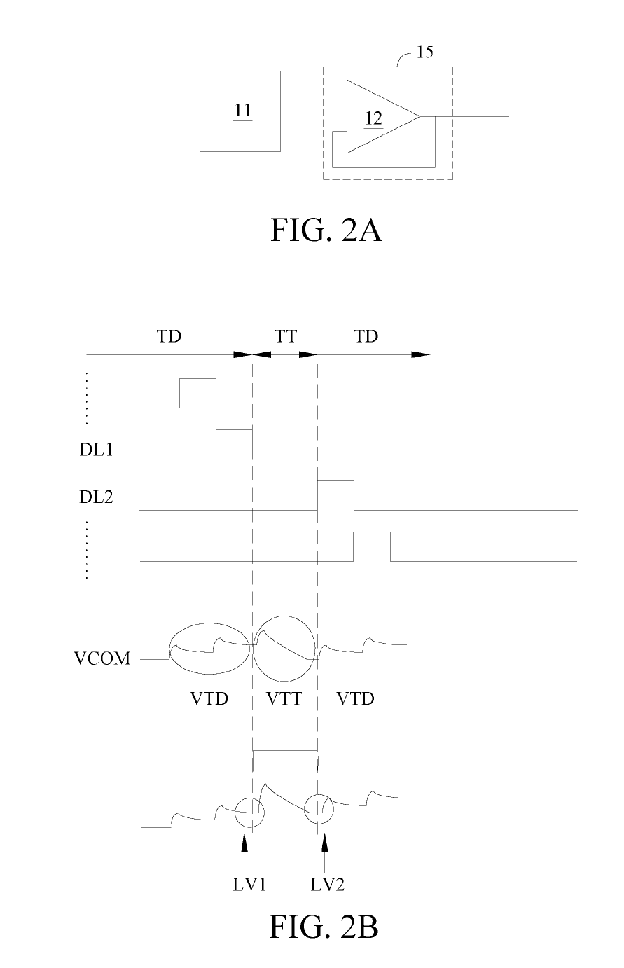

Referring to FIG. 2A and FIG. 2B, a driving circuit of the present invention includes a determining module 11 and a compensating module 12. In this embodiment, the driving circuit is applied to an In-cell touch display panel. It should be noted herein that the touch display panel is operated in a touch mode in a touch period TT and is operated in data driving mode in a data driving period TD. The touch period TT occurs between the data driving period TD corresponding to a first data line DL1 and another data driving period TD corresponding to the second data line DL2, that is, a period between two driving periods TD in the figure.

A common voltage VCOM of the touch display panel has a first level LV1 when the data driving period TD corresponding to the first data line DL1 ends, and the common voltage VCOM has a second level LV2 when the another data driving period TD corresponding to the second data line DL2 starts. In this embodiment, the compensating module 15 is coupled to the determining module 11, and is an operational amplifier 12 (OPAMP), configured to control (e.g., drive, provide, and/or adjust) the common voltage VCOM. The determining module 11 may be a voltage sensing circuit, but is not limited thereto.

As shown in the figure, the determining module 11 determines the first level LV1 and the second level LV2. The determining module 11 determines whether a difference between the first level LV1 and the second level LV2 is greater than a preset value. When a determining result of the determining module 11 is that the difference between the first level LV1 and the second level LV2 is greater than the preset value, the compensating module 15 compensates the common voltage VCOM in the touch period TT, so that the first level LV1 and the second level LV2 are substantially equal. It should be noted that the preset value in this embodiment may be set based on different requirements, and is not particularly limited.

For example, continue to refer to FIG. 2A and FIG. 2B. In this embodiment, the first level LV1 that corresponds to the common voltage VCOM when the data driving period TD of the first data line DL1 ends is greater than the second level LV2 that corresponds to the common voltage VCOM when the another data driving period TD of the second data line DL2 starts. The determining module 11 determines that the difference between the first level LV1 and the second level LV2 is greater than the preset value. At this time, the compensating module 15 compensates the common voltage VCOM by changing a driving voltage output by the operational amplifier 12 in the touch period TT. For example, the compensating module 15 increases the driving voltage output by the operational amplifier 12 in the touch period TD, to increase the second level LV2 to be substantially equal to the first level LV1. As shown in FIG. 2B, the first level LV1 and the second level LV2 are substantially equal. Therefore, a line or a stripe originally on a display image can be eliminated.

It should be noted that if the determining result of the determining module is that the difference between the first level LV1 and the second level LV2 is not greater than the preset value, the compensating module 15 is switched off, and cannot compensate the common voltage VCOM in the touch period TT.

In an actual application, the determining module 11 determines a voltage difference between the common voltage VCOM when touch sensing starts and the common voltage VCOM when the touch sensing ends, that is, determines whether the difference between the first level LV1 of the common voltage VCOM when the data driving period TD ends (when the touch period TT starts) and the second level LV2 of the common voltage VCOM when the another data driving period TD starts (when the touch period TT ends) is greater than the preset value. If the difference between the first level LV1 and the second level LV2 is greater than the preset value, the compensating module 15 increases the driving voltage output in the touch period TD; or if the difference between the first level LV1 and the second level LV2 is not greater than the preset value, the compensating module 15 does not perform compensation.

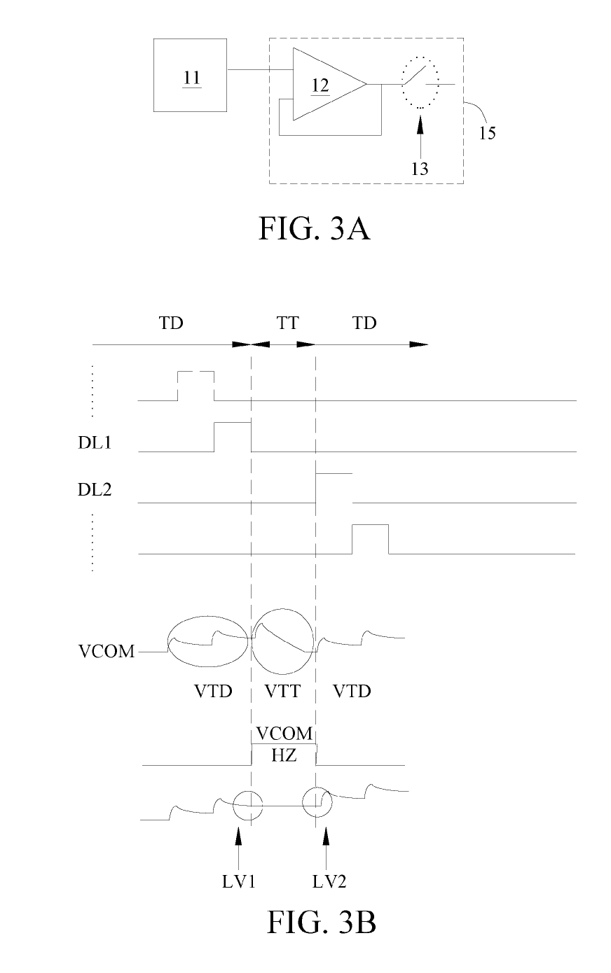

For another embodiment of the present invention, refer to FIG. 3A and FIG. 3B. In this embodiment, similarly, a first level LV1 of a common voltage VCOM when a data driving period TD corresponding to a first data line DL1 ends is greater than a second level LV2 of the common voltage VCOM when another data driving period TD corresponding to a second data line DL2 starts. After a determining module 11 determines such state, a compensating module 15 also compensates the common voltage VCOM. A difference from the foregoing embodiment is that the compensating module 15 in this embodiment includes an operational amplifier 12 and a high-resistance switch 13, but is not limited thereto. The high-resistance switch 13 is coupled to an output end of the operational amplifier 12.

In this embodiment, the high-resistance switch 13 is turned on and off, and the first level LV1 is greater than the second level LV2. Therefore, the compensating module 15 turns on (off) the high-resistance switch 13 in the touch period TT, so that the common voltage VCOM is maintained the same. Due to lack of driving of the operational amplifier 12, the common voltage VCOM cannot be restored to the output value of the operational amplifier 12. That is, a fixed value is maintained. Briefly, the common voltage VCOM is maintained unchanged in the touch period TT, so that the first level LV1 and the second level LV2 are substantially equal. Therefore, the first data line DL1 and the second data line DL2 can have substantially equal common voltages VCOM when they are driven. As shown in the figure, the first level LV1 and the second level LV2 are equal. Based on this design, a line or a stripe originally on a display image can be eliminated.

Another embodiment of the present invention provides an operating method applicable to the foregoing driving circuit, and is applied to an In-cell touch display panel. The touch display panel is operated in a touch mode in a touch period, and is operated in a data driving mode in a data driving period. The touch period occurs between the data driving period corresponding to a first data line and another data driving period corresponding to a second data line. A common voltage (VCOM) of the touch display panel has a first level when the data driving period TD corresponding to the first data line ends, and the common voltage has a second level when the another data driving period corresponding to the second data line starts.

The driving circuit includes a determining module and a compensating module. The operating method includes the following steps: (S1) the determining module determines whether a difference between the first level and the second level is greater than a preset value; and (S2) if a determining result of the determining module is that the difference between the first level and the second level is greater than the preset value, the compensating module compensates the common voltage in the touch period, so that the first level and the second level are substantially equal.

It should be noted that if the determining result in step (S1) is that the difference between the first level and the second level is not greater than the preset value, step (S3) is performed. The compensating module is switched off, and cannot compensate the common voltage in the touch period.

In this embodiment, the compensating module includes an operational amplifier (OPAMP), configured to control (e.g., drive, provide, and/or adjust) the common voltage. When the determining result of the determining module is that the difference between the first level and the second level is greater than the preset value, the compensating module compensates the common voltage by changing a driving voltage output by the operational amplifier in the touch period. For example, when the second level is less than the first level, the compensating module increases the driving voltage output by the operational amplifier in the touch period, so that the second level is increased to be substantially equal to the first level.

In another embodiment, a compensating module includes an operational amplifier and a high-resistance switch. The high-resistance switch is coupled to an output end of the operational amplifier, so that a common voltage is maintained unchanged in a touch period, and a first level and a second level are substantially equal.

Details of actions of the elements in the foregoing embodiments are similar to those in the device embodiments, and details are not described herein. Based on this design, a line or a stripe originally on a display image can be eliminated.

The foregoing specific embodiments are described in detail to more clearly describe features and the spirit of the present invention rather than limit the scope of the present invention. A person skilled in the art may make various alternations and modifications without departing from the sprit and scope of the present invention. Therefore, the protection scope of the present invention shall be subject to the scope defined by the appended claims.

What is claimed is:

1. A driving circuit, applied to an In-cell touch display panel, wherein the touch display panel is operated in a touch mode in a touch period and is operated in a data driving mode in a data driving period, the touch period occurs between the data driving period corresponding to a first data line and another data driving period corresponding to a second data line, a common voltage of the touch display panel has a first level when the data driving period corresponding to the first data line ends, and the common voltage has a second level when the another data driving period corresponding to the second data line starts, the driving circuit comprising:
a determining module, configured to determine whether a difference between the first level and the second level is greater than a preset value; and
a compensating module, coupled to the determining module, wherein under a condition that a determining result of the determining module is that the difference between the first level and the second level is greater than the preset value, the compensating module compensates the common voltage in the touch period, so that the first level and the second level are substantially equal.

2. The driving circuit according to claim 1, wherein the compensating module comprises an operational amplifier, configured to control the common voltage, and under a condition that the determining result of the determining module is that the difference between the first level and the second level is greater than the preset value, the compensating module compensates the common voltage by changing a driving voltage output by the operational amplifier in the touch period.

3. The driving circuit according to claim 2, wherein under a condition that the determining result of the determining module is that the difference between the first level and the second level is greater than the preset value and the second level is less than the first level, the compensating module increases the driving voltage output by the operational amplifier in the touch period, so that the second level is increased to be substantially equal to the first level.

4. The driving circuit according to claim 1, wherein the compensating module comprises an operational amplifier and a high-resistance switch, the high-resistance switch is coupled to an output end of the operational amplifier, so that the common voltage is maintained unchanged in the touch period, and the first level and the second level are substantially equal.

5. The driving circuit according to claim 1, wherein under a condition that the determining result of the determining module is that the difference between the first level and the second level is not greater than the preset value, the compensating module is switched off and is not able to compensate the common voltage in the touch period.

6. An operating method for a driving circuit, applied to an In-cell touch display panel, wherein the touch display panel is operated in a touch mode in a touch period and is operated in a data driving mode in a data driving period, the touch period occurs between the data driving period corresponding to a first data line and another data driving period corresponding to a second data line, a common voltage of the touch display panel has a first level when the data driving period corresponding to the first data line ends, the common voltage has a second level when the another data driving period corresponding to the second data line starts, and the driving circuit comprises a determining module and a compensating module, the operating method comprising the following steps:
(S1) the determining module determines whether a difference between the first level and the second level is greater than a preset value; and
(S2) under a condition that a determining result of the determining module is that the difference between the first level and the second level is greater than the preset value, the compensating module compensates the common voltage in the touch period, so that the first level and the second level are substantially equal.

7. The operating method according to claim 6, further comprising the following step:
(S3) under a condition that the determining result of the determining module is that the difference between the first level and the second level is not greater than the preset value, the compensating module is switched off and is not able to compensate the common voltage in the touch period.

8. The operating method according to claim 6, wherein the compensating module comprises an operational amplifier, configured to control the common voltage, and under a condition that the determining result of the determining module is that the difference between the first level and the second level is greater than the preset value, the compensating module compensates the common voltage by changing a driving voltage output by the operational amplifier in the touch period.

9. The operating method according to claim 8, wherein under a condition that the determining result of the determining module is that the difference between the first level and the second level is greater than the preset value and the second level is less than the first level, the compensating module increases the driving voltage output by the operational amplifier in the touch period, so that the second level is increased to be substantially equal to the first level.

10. The operating method according to claim 6, wherein the compensating module comprises an operational amplifier and a high-resistance switch, the high-resistance switch is coupled to an output end of the operational amplifier, so that the common voltage is maintained unchanged in the touch period, and the first level and the second level are substantially equal.
